(19) United States
(12) Patent Application Publication
(10) Pub. No.: US 2013/0244312 A1
(43) Pub. Date: Sep. 19, 2013

(54) SYSTEMS AND METHODS FOR CARBON DIOXIDE ABSORPTION

(71) Applicants: David W. Larkin, Bartlesville, OK (US); Clint P. Aichele, Stillwater, OK (US); Debangshu Guha, Kingsport, TN (US)

(72) Inventors: David W. Larkin, Bartlesville, OK (US); Clint P. Aichele, Stillwater, OK (US); Debangshu Guha, Kingsport, TN (US)

(73) Assignee: PHILLIPS 66 COMPANY, Houston, TX (US)

(21) Appl. No.: 13/614,670

(22) Filed: Sep. 13, 2012

Related U.S. Application Data
(60) Provisional application No. 61/551,704, filed on Oct. 26, 2011.

(51) Int. Cl. B01D 53/62; C10L 3/10

(52) U.S. Cl. CPC B01D 53/62; C10L 3/104
USPC 435/266; 423/228; 435/283.1; 585/802

(57) ABSTRACT

The disclosure pertains to removal of carbon dioxide from industrial gas streams. Processes and systems are disclosed for capturing carbon dioxide from a combustion flue gas or from uncombusted natural gas by contacting with an amine blend in a first step, and an advanced solvent in a second step. The processes and systems disclosed herein increase the efficiency of carbon dioxide removal while extending the lifespan of the solvents utilized

### CROSS-REFERENCE TO RELATED APPLICATIONS

This application is a non-provisional application which claims benefit under 35 USC §119(e) to U.S. Provisional Application Ser. No. 61/551,704 filed Oct. 26, 2011, entitled SYSTEMS AND METHODS FOR CARBON DIOXIDE ABSORPTION, which is incorporated herein in its entirety.

### STATEMENT REGARDING FEDERALLY SPONSORED RESEARCH OR DEVELOPMENT

None.

### FIELD OF THE INVENTION

The disclosure pertains to carbon dioxide removal from industrial gas streams. More specifically, the current disclosure pertains to multi-step processes and systems for capturing carbon dioxide from a flue gas or from uncombusted natural gas by contacting with an amine blend in a first step, and an enzyme in a second step.

### BACKGROUND

The process of steam assisted gravity drainage (SAGD) is often utilized to assist in the production of heavy oil from subterranean hydrocarbon deposits. Use of SAGD is projected to increase in the coming years, yet, generating steam for the SAGD process is energy-intensive and a significant source of carbon dioxide emissions. Canadian and US government regulations are being considered that may soon require companies to show incremental decreases in annual emissions of carbon dioxide (CO₂). As a result, oil sand upgrading facilities, SAGD facilities, and even hydrocarbon refinery facilities built after 2012 may require implementation of technologies to capture and store at least a portion of the CO₂ produced by these operations. Apart from the potential for increasing regulatory requirements, there is a growing concern among the scientific community that excessive CO₂ emissions are altering the earth's climate. Thus, finding efficient ways to decrease CO₂ emissions from SAGD operations, and from combustion flue gases in general, is a priority.

One of the biggest challenges of using amine-based solvents for CO₂ capture is the quantity of heating needed to regenerate the amine for reuse. The energy input required is governed by the circulation rate of the solvent in the system, which in turn, is dictated by the carbon dioxide absorption rate into the solvent. Researchers have investigated various amines and amine blends to lower the energy input required to regenerate the amine solvent. However, amine systems currently employed lack sufficient activity to enable a significant decrease in the amine recirculation rate required to enable significant CO₂ capture.

Various enzyme systems have also been investigated for increasing CO₂ capture efficiency, including carbonic anhydrases capable of converting absorbed CO₂ to bicarbonate to increase the efficiency of the CO₂ removal process. Unfortunately, enzyme-based systems are expensive to operate—requiring constant replenishment of the enzyme—and thus, remain too expensive for industrial scale CO₂ removal. Mixing an amine solvent with an enzyme has also been proposed for increasing the efficiency of CO₂ removal, but once again, the enzymes have a relatively short catalytic lifespan at the conditions of temperature and pressure typically required for CO₂ absorption and regeneration of an amine solvent. This necessitates constant re-addition of fresh enzyme, making this option economically unattractive.

Accordingly, a need exists for processes and systems for CO₂ recovery that are cheaper to construct, and are also more efficient and less costly to operate. The current disclosure provides processes and systems that achieve all of these goals.

### BRIEF SUMMARY

Certain embodiments comprise a process for the removal of carbon dioxide from a gas, comprising: passing a first gas comprising carbon-dioxide into a first absorption zone; contacting the first gas with a liquid amine solvent in the first absorption zone and transferring a portion of the carbon dioxide in the first gas to the liquid amine solvent to produce a second gas comprising a reduced quantity of carbon dioxide relative to the first gas and a carbon dioxide-laden liquid amine solvent; passing the second gas to a second absorption zone, and contacting therein with an advanced solvent comprising an ionic liquid or an enzyme; transferring at least a portion of the carbon dioxide in the second gas to the advanced solvent to produce a third gas comprising a reduced quantity of carbon dioxide relative to the second gas and a spent advanced solvent; conveying the carbon dioxide-laden liquid amine solvent to a first regeneration zone, where the first regeneration zone is maintained at a temperature and pressure sufficient to liberate carbon dioxide from the carbon dioxide-laden liquid amine solvent, thereby producing a regenerated liquid amine solvent that is at least partly recycled to the first absorption zone; conveying the spent advanced solvent to a second regeneration zone that is maintained at a temperature and pressure sufficient to liberate carbon dioxide from the spent advanced solvent, thereby producing a regenerated advanced solvent that is at least partly recycled to the second absorption zone, where the temperature within the second regeneration zone is less than the temperature of the first regeneration zone, thereby prolonging the activity of the advanced solvent.

In certain embodiments of the process, the first absorption zone and the second absorption zone may be located in adjoining, but separate zones within a single absorption vessel or column. Generally, the liquid amine solvent is comprised of about 10 wt. % to about 20 wt. % monoethanolamine, about 4 wt. % to about 35 wt. % methyl diethanolamine, and about 5 wt. % to about 45 wt. % piperazine.

In certain embodiments of the process, the liquid amine solvent is regenerated in a first regeneration zone, and the advanced solvent is regenerated under milder conditions in a second regeneration zone to extend the useable lifespan of the advanced solvent. The temperature in the first regeneration zone is maintained generally in a range of about 180° F. to about 280° F. and the pressure is maintained in a range of about 0 psig to about 50 psig. The temperature in the second regeneration zone is maintained at a temperature in a range from about 104° F. to about 194° F. and a pressure in a range from about 0 psig to about 50 psig. In certain embodiments, the advanced solvent is an ionic liquid capable of absorbing carbon dioxide, while in other embodiments, the advanced solvent may comprise an enzyme, such as a form of carbonic anhydrase (CA). The process is generally applicable to the treating of both flue gases as well as produced natural gas that contains CO₂.

In certain embodiments of the process, the first absorption zone is maintained at a temperature in the range of 40° F. to 175° F. and a pressure of up to about 50 psig, while the first regeneration zone is maintained a temperature in a range from about 180° F. to about 280° F. and a pressure of up to about 50 psig.

In certain embodiments where the advanced solvent comprises an enzyme, a genetically-modified enzyme, a synthetic analogue of an enzyme, or mixtures of these, the second absorption zone is maintained at a temperature of less than 140° F. and a pressure of up to about 50 psig, while the second regeneration zone is maintained a temperature in a range from about 104° F. to about 194° F. and a pressure of up to about 50 psig.

In certain embodiments where the advanced solvent comprises an ionic liquid, the second absorption zone is maintained at a temperature in a range from about 104° F. to about 575° F. and a pressure of up to about 50 psig, while the second regeneration zone is maintained at a temperature in a range of about 104° F. to about 220° F. and a pressure of up to about 50 psig.

Certain embodiments comprise a system for the removal of carbon dioxide from a gas, including: a) a liquid amine solvent; b) a first absorption zone suitable for containing the liquid amine solvent, receiving a first gas comprising carbon dioxide, and allowing direct contact between the liquid amine solvent and the first gas, thereby facilitating the transfer of carbon dioxide from the first gas to the liquid amine solvent and producing a second gas and a carbon dioxide-laden liquid amine solvent; c) an advanced solvent comprising an ionic liquid or an enzyme; d) a second absorption zone that is separate from the first absorption zone, and suitable for containing the advanced solvent, receiving the second gas, and allowing direct contact between the advanced solvent and the second gas, thereby facilitating transfer of at least a portion of the carbon dioxide from the second gas to the advanced solvent and producing a third gas and a spent advanced sorbent; e) a first regeneration zone suitable for receiving the carbon dioxide-laden liquid amine solvent from a first absorption zone, and maintaining conditions of temperature and pressure that facilitate the removal of carbon dioxide from the carbon dioxide-laden liquid amine solvent; a second regeneration zone that is separate from the first regeneration zone, and suitable for receiving the carbon dioxide-laden advanced solvent from the second absorption zone, and adapted to maintain conditions of temperature and pressure that facilitate the liberation of carbon dioxide from the spent advanced solvent, wherein the temperature is less than the temperature maintained in the first regeneration zone.

In certain embodiments of the system, the liquid amine solvent comprises monoethanolamine, methyl diethanolamine and piperazine, wherein monoethanolamine comprises about 10 wt. % to about 20 wt. %, methyl diethanolamine comprises about 4 wt. % to about 35 wt. %, and piperazine comprises from about 5 wt. % to about 45 wt. % of the liquid amine solvent.

In certain embodiments of the system, the first regeneration zone is adapted to regenerate the liquid amine solvent, and the second regeneration zone is adapted to regenerate the advanced solvent, where the second regeneration zone is physically separated from the first regeneration zone. Generally, the first absorption zone is adapted to maintain a temperature in the range of 40° F. to 175° F. and a pressure of up to about 50 psig, and the first regeneration zone is adapted to maintain a temperature in a range from about 180° F. to about 280° F. and a pressure of up to about 50 psig.

In certain embodiments of the system, the advanced solvent comprises an enzyme, a genetically-modified enzyme, a synthetic analogue of an enzyme or mixtures thereof. In these embodiments, the second absorption zone is adapted to maintain a temperature of less than about 140° F. and a pressure of up to about 50 psig, while the second regeneration zone is adapted to maintain a temperature in a range from about 104° F. to about 194° F. and a pressure of up to about 50 psig. The milder temperatures of the second regeneration zone may serve to extend the lifespan of the advanced solvent.

In certain embodiments of the system, the advanced solvent comprises an ionic liquid. In these embodiments, the second absorption zone is adapted to maintain a temperature in a range from about 104° F. to about 575° F. and a pressure of up to about 50 psig, while the second regeneration zone is suitable for maintaining a temperature in a range of about 104° F. to about 220° F. and a pressure of up to about 50 psig.

In certain embodiments of the system, the first regeneration zone and the second regeneration zone are adjoining within a single absorption vessel and are physically separated in order to prevent mixing of the liquid amine solvent and the advanced solvent.

In certain embodiments of the system, the advanced solvent comprises an ionic liquid capable of absorbing carbon dioxide, while in certain alternative embodiments the advanced solvent comprises an enzyme, such as a form of CA. The advanced solvent is generally regenerated in a second regeneration zone that is maintained at a temperature in a range of about 104° F. to about 220° F. and a pressure in a range of about 0 psig to about 50 psig.

The processes and systems of the current disclosure reduce the overall energy required for CO₂ capture from flue gases as compared to conventional processes. Further, the system of the current disclosure has a decreased capital cost due to reductions in solvent circulation rate and contactor size enabled by use of an optimized liquid amine mixture.

### BRIEF DESCRIPTION OF THE DRAWINGS

A more complete understanding of the present invention and benefits thereof may be acquired by referring to the follow description taken in conjunction with the accompanying drawings in which:

FIG. 1 depicts a flow diagram for a typical amine scrubbing process for removing CO₂ from a flue gas.

FIG. 2 depicts a flow diagram of one embodiment, an amine scrubbing process in which the absorber is designed to remove a first portion of CO₂ from a flue gas using a circulating liquid amine solution in a first absorption zone, then remove a second portion of CO₂ from the flue gas using a high-activity advanced solvent in a second absorption zone.

FIG. 3 is a graph showing the relative reboiler duty (i.e., regeneration energy) for various mixtures of MDEA, MEA and piperazine.

FIG. 4 is a graph depicting the relative reboiler duty for several ratios of MEA:MDEA in the presence of 15 wt % piperazine.

FIG. 5 is a graph depicting relative reboiler duty for various amine mixtures.

The invention is susceptible to various modifications and alternative forms, specific embodiments are shown by way of example in the drawings. The drawings may not be to scale. It should be understood that the drawings and their accompanying detailed descriptions are not intended to limit the scope of the invention to the particular form disclosed, but rather, the intention is to cover all modifications, equivalents and alternatives falling within the spirit and scope of the present invention as defined by the appended claims.

### DETAILED DESCRIPTION

Amine absorption of CO₂ uses an aqueous amine solvent to absorb CO₂ from a flue gas. The overall reaction between CO₂ and a primary or secondary amine is thought to proceed through a zwitterionic mechanism in which a carbamate is formed. Not intending to be bound by theory, it is generally believed that the first step in the reaction is the formation of the intermediate zwitterion. In the second step, a base de-protonates the intermediate zwitterion to form a carbamate. Tertiary amines have no labile hydrogen and, therefore, require water to be present in order to interact with CO₂. Specifically, a slow hydrolysis mechanism occurs in which a proton and hydroxyl group is transferred to the tertiary amine and CO₂, respectively (eq. 1). In the case of the latter, a bicarbonate ion is formed.

CO₂+H₂O+R₃N [symbol] R₃NH⁺+HCO3⁻ (eq. 1)

The equilibrium of the overall carbamate reaction and bicarbonate reaction (eq. 1) moves to the right under high pressure and low temperature, while shifting to the left under the opposite conditions. Amine scrubbing takes advantage of this equilibrium characteristic mainly through temperature. Both the absorber and regenerator are close to ambient pressures, but their temperatures are significantly different. In a conventional amine scrubbing process, the absorber temperature is fairly low (approximately 40° F. to 175° F.) to enable maximum CO₂ loading of the amine, while the regenerator temperature is much higher for CO₂ stripping (180° F. to 280° F.).

The concentration of CO₂ in flue gas is low (ranging from 3-14 mole %), necessitating the use of a highly reactive amine to absorb a significant percentage of the CO₂. Primary amines are highly reactive derivatives of ammonia, in which one hydrogen atom has been replaced by a substituent such as an alkyl or aryl group. Secondary amines have two hydrogen atoms replaced by substituent groups, and tertiary amines have all three hydrogen atoms replaced with these groups. Monoethanolamine (MEA) is a primary amine that is highly reactive and has been widely-used in industrial amine scrubbing processes.

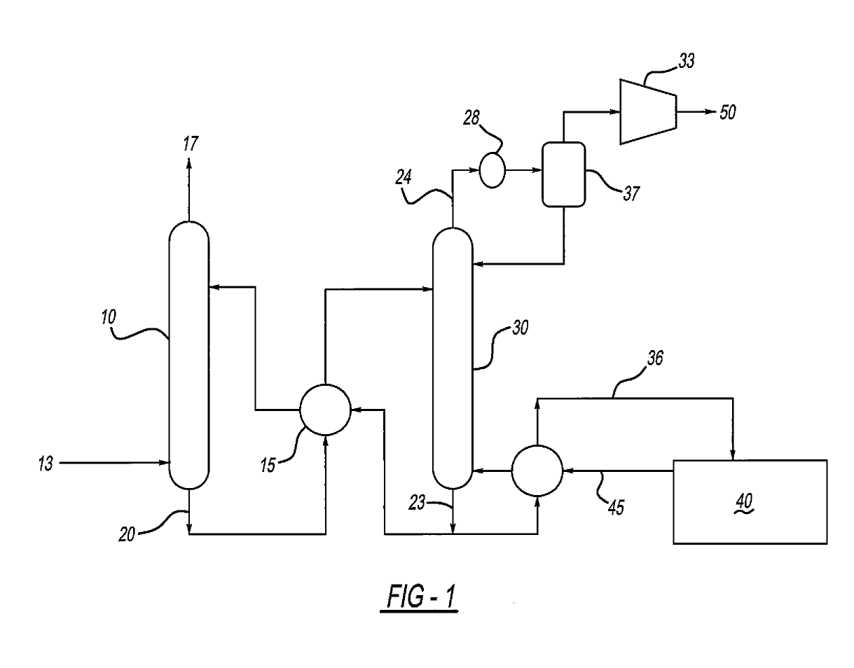

A conventional amine scrubbing process for the removal of CO₂ from a combustion flue gas is shown in FIG. 1. It includes an absorber unit 10, a regenerator unit 30, and accessory equipment. In the absorber, an amine solution absorbs CO₂ from a gas 13 producing a CO₂ lean flue gas stream 17 and a CO₂ rich amine solution 20. The resultant rich CO₂ amine solution is routed to the regenerator 30 that receives steam 45 from a boiler 40. The regenerator 30 produces a regenerated lean amine stream 23 that is cooled in a heat exchanger 15, and recycled back to the absorber 10 for re-use. The regenerator overhead gas 24 is concentrated CO₂ and steam, which is cooled 28 whereupon the steam condenses 37 and is returned to the regenerator. The remaining CO₂ can then be compressed 33 and sent to a pipeline for storage/sequestration 50.

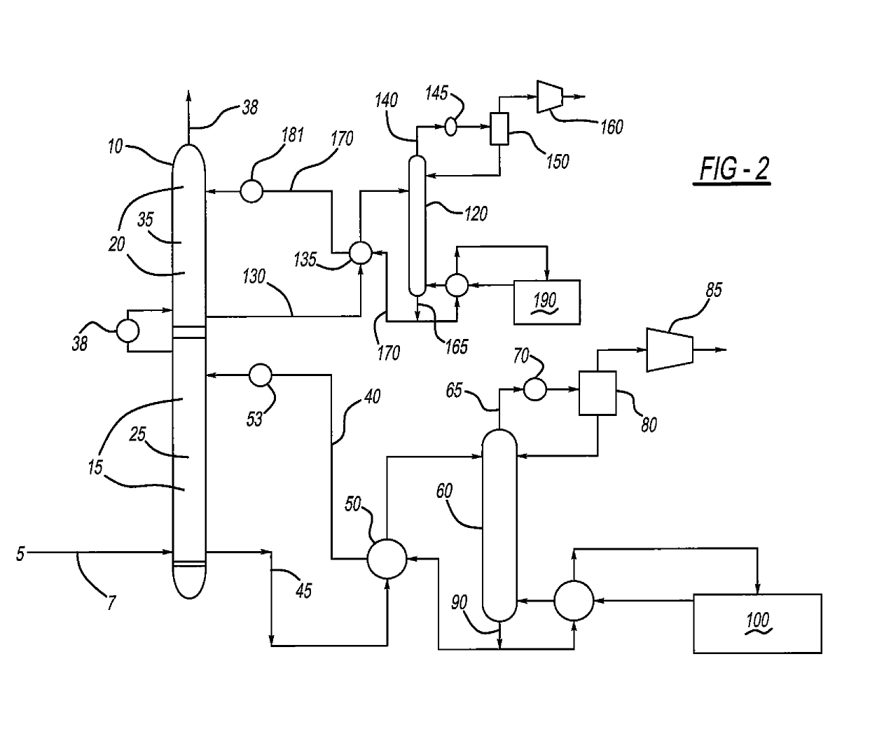

The current disclosure comprises a two step process and system that utilizes a liquid amine solvent in a first step to remove a first portion of the CO₂ present in a gas, then more fully treating a gas by contacting it with a high-activity solvent in a second step that removes a second portion of CO₂ from the gas. One embodiment of these processes and systems is depicted in FIG. 2, which shows a vessel 10 that is divided into a first absorption zone 15 and a second absorption zone 20. The first absorption zone utilizes a liquid amine solvent 25 that is input via line 40 and falls by gravity flow through the first absorption zone where it contacts a gas 5 that enters the first absorption zone 15 via line 7. Once the liquid amine solvent is laden with CO₂, it leaves the vessel via line 45, is heated in heat exchanger 50, then enters a vessel comprising a first regeneration zone 60, where CO₂ is liberated from the liquid amine solvent and leaves via line 65. Liberated CO₂ may then be cooled 70, de-moisturized 80 and compressed 85.

The regenerated liquid amine solvent leaves the regenerator 60 via line 90, is cooled by heat exchanger 50, and is returned to the top of the first absorption zone 15 via line 40. The liquid amine solvent may be further cooled by heat exchanger 53 prior to introduction to the first absorption zone. Water leaving the first regeneration zone is reheated in regeneration boiler 100 and returned as steam to the first regeneration zone 60.

The liquid amine solvent 25 absorbs CO₂ more effectively at the relatively high partial pressures of CO₂ present in the first absorption zone 15, while also removing other contaminants from the gas that may degrade the CO₂ absorption activity of the advanced solvent. The gas then moves from the first absorption zone to the second absorption zone 20. In certain embodiments, the first absorption zone 15 and second absorption zone 20 may be adjacent zones in a single absorber or vessel 10 that is designed to minimize the amount of liquid amine solvent in the first absorption zone from coming into contact with the advanced solvent in the second absorption zone. Such separation may be achieved by a water spray at the top of the first absorption zone that prevents the amine from exiting the first absorption zone, an external water quench vessel 38 (as depicted in FIG. 2) through which the gas is conducted after exiting the first absorption zone (and prior to entering the second absorption zone), or a membrane that physically divides the two zones that is selectively-permeable to gas but not the solvents utilized in each zone. Such mechanisms for separation are conventional and may be implemented by one having skill in the art.

Once the gas 5 enters the second absorption zone 20, it is contacted with an advanced solvent 35 having high-activity that is optimized to efficiently absorb a large percentage of any CO₂ remaining in the gas. The advanced solvent 35 is typically a non-amine solvent with the ability to absorb a high level of CO₂, such as, but not limited to, an ionic liquid or a solvent comprising an enzyme that is capable of converting absorbed CO₂ to bicarbonate ion, such as a form of carbonic anhydrase (CA).

Upon contacting between the advanced solvent 35 and the gas 5, a portion of the remaining CO₂ present in the gas 5 transfers to the advanced solvent 35. The gas 5 then exits via a line 38 near the top of the second absorption zone 20. Advanced solvent that is laden with CO2 exits via a line 130 near the bottom of the second absorption zone 20, is heated in heat exchanger 135, then enters a vessel comprising a second regeneration zone 120, where CO₂ is liberated from the advanced solvent leaves via line 140. Liberated CO₂ may then be cooled 145, de-moisturized 150 and compressed 160. The compressed CO₂ streams 85 and 160 may be combined, and may be transported to another site via pipeline or truck for storage or injection into a subterranean formation (not depicted).

The regenerated advanced solvent leaves the regenerator 120 via line 165, is cooled by heat exchanger 135, and is returned to the top of the second absorption zone 20 via line 170. The advanced solvent may be further cooled by heat exchanger 181 prior to introduction to the first absorption zone 15. Water leaving the second regeneration zone is reheated in regeneration boiler 190 and returned as steam to the second regeneration zone 120.

The two-zone CO₂ removal processes and systems of the current disclosure optimize the relative amount of CO₂ captured by both the liquid amine solvent in a first absorption zone, and the advanced solvent in a second absorption zone, thereby increasing efficiency versus conventional one-step processes for absorbing CO₂ from a gas. The inlet gas, at relatively higher carbon dioxide concentration, is first contacted with the amine solvent to partially absorb the carbon dioxide and certain contaminants. After the first step, the gas is significantly reduced in CO₂ concentration, and is then treated with a high activity solvent in a second step that is optimized to efficiently absorb a large percentage of any CO₂ remaining in the gas. This ensures that the carbon dioxide absorption rate is maintained as high as possible even at relatively low concentrations of CO₂, while also absorbing (and thereby removing) many harmful contaminants in the first step, which in turn, helps preserve the activity of the advanced solvent in the second step. An additional benefit of the sequential, two-step arrangement is that it minimizes the operational expense for CO₂ removal because the advanced solvent 35 is largely (or in some embodiments, entirely) isolated from the liquid amine solvent, allowing the advanced solvent to be regenerated separately in a second regeneration zone using conditions that extend the functional or operational lifespan of the advanced solvent.

In certain embodiments, containing both absorption zones within in a single absorber or vessel further minimizes the capital expenditure required to build the inventive system, as well as the expense to perform the inventive process. The less expensive liquid amine solvent absorbs not only CO₂, but also other contaminants that can lead to solvent degradation, before coming into contact with the more expensive advanced solvent. This extends the lifespan of the advanced solvent, which is typically much more expensive than the liquid amine solvent used in the first absorption zone. Additionally, separation of the liquid amine solvent and the advanced solvent into separate absorption zones allows the advanced solvent to be regenerated at more mild temperatures (and optionally, pressure) which can further extend the useful lifespan of the more expensive advanced solvent. Operating conditions of the regenerators and each absorption zone can be tailored to achieve optimum results for the given solvent utilized.

The higher CO₂ absorption activity of the advance solvent in the second absorption zone make this solvent better-suited to removing the relatively lower levels of CO₂ that remain in the flue gas upon exiting the first absorption zone. This increased CO₂ absorption activity also decreases the required solvent circulation rate and packing volume required to absorb a significant portion of the CO₂ that remains in the flue gas after leaving the first absorption zone. This allows the size of the second absorption zone to be minimized, thereby increasing efficiency and decreasing cost. Additionally, the advanced solvent requires less energy to be regenerated for reuse than an equivalent amount of liquid amine solvent, which also increases the efficiency of the process.

Contact between the flue gas and the solvent in each absorption zone is typically performed in an absorption column or vessel capable of maximizing contact between the flue gas and the solvent. Techniques for maximizing contact are known and may include, but are not limited to use of spray columns or bubble columns, as well as gravity flow through packing, on wires, screens, or any combination of these methods.

In certain embodiments, the advanced solvent utilized in the second absorption zone may be an ionic liquid (IL) capable of absorbing a portion of the carbon dioxide remaining after the gas contacts the liquid amine solvent in the first absorption zone. Ionic liquids (ILs) are a broad category of salts, typically containing an organic cation and either an inorganic or organic anion. The use of ionic liquids for CO₂ capture has gained interest due to their unique characteristics, i.e., wide liquid ranges, thermal stabilities, negligible vapor pressures up to their thermal decomposition points, tunable physicochemical characters, and high solubility for CO₂. Additionally, since ILs are physical solvents, little heat is required for their regeneration. Many ionic liquids have been developed in recent years that are capable of absorbing CO₂, and selecting an ionic liquid suitable for use in the current invention is within the ability of one having average skill in the art. In certain embodiments, an ionic liquid would be chosen with both high CO₂ solubility and a low regeneration temperature in order to save on operational expense. Examples of ionic liquids useful with the processes and systems described herein include, but are not limited to: 1-hexl-3-methylpyridinium bis(trifluoromethylsulfonyl)imide, 1-hexl-3-methylimidazolium bis(trifluoromethylsulfonyl)imide, and 1-hexl-3-methylimidazolium hexafluorophosphate.

As noted above, the advanced solvent utilized in the second absorption zone may comprise an enzyme that may be a form of naturally-occurring CA. The carbonic anhydrases are a family of enzymes that catalyze the rapid inter-conversion of carbon dioxide and water to bicarbonate and a proton, and depending upon conditions, also catalyze the reverse reaction. The naturally-occurring carbonic anhydrases are grouped into different classes that appear to be genetically unrelated, but may have developed similar enzymatic function through processes of convergent evolution. The known classes of CA (alpha, beta, gamma, delta, and epsilon) have been extensively studied and are familiar to those having knowledge in the art. The reaction rate of CA is among the fastest of all enzymes, such that reaction rate is typically limited by the diffusion rate of its substrates. Typical catalytic rates of the different forms of this enzyme range between 10⁴ and 10⁶ reactions per second.

In certain embodiments, the advanced solvent may comprise a genetically-modified isoform of CA. Genetically-modified isoforms of CA have been created that are designed to be more stable to the harsh conditions often associated with industrial CO₂ capture processes. Such genetic modifications may make the enzyme resistant to, for example, thermal denaturation or degradation. A more detailed description of genetically-modified isoforms of CA is outside the scope of the current disclosure, and the use of such modified enzymes with the processes and systems disclosed herein can be understood and implemented by those having skill in the art.

In certain alternative embodiments, the advanced solvent may comprise a synthetic analogue of CA. Such analogues are chemically synthesized rather than produced by one or more genetic modifications that lead to substitution of specific amino acids in the enzyme. A more detailed description of synthetic analogues of CA is outside the scope of the current disclosure, and the use of such analogues with the processes and systems disclosed herein can be understood and implemented by those having skill in the art.

CA is known to be at least 4000 times more reactive with CO₂ than the commonly utilized amine monoethanolamine (MEA). Thus, utilizing CA as a component of the advanced solvent in the second absorption zone greatly enhances the removal of carbon dioxide in the second absorption zone by rapidly converting CO₂ absorbed by the advanced solvent into bicarbonate (HCO₃⁻) and a proton (H⁺). This conversion increases the amount of CO₂ that can be absorbed by the solvent.

In addition to removing CO₂ from flue gas, certain embodiments utilize the processes and systems of the current disclosure for treating any uncombusted natural gas containing CO₂ in order to decrease the CO₂ content and capture the CO₂ for storage or reinjection into an underground formation.

The liquid amine solvent utilized in the first absorption zone may comprise a mixture of amines that is capable of more rapid absorption of CO₂, and requiring less energy for regeneration than using MEA alone. Any mixture of primary, secondary, and tertiary amines known to be useful for the absorption of CO₂ may be utilized with the embodiments described herein. Certain embodiments utilize an liquid amine solvent that comprises at least two fast-reaction rate amines and one slow reaction rate amine. Preferably, the liquid amine solvent comprises a mixture of the fast-reaction rate amines (MEA) and piperazine (PZ), and the slow-reaction rate amine MDEA. Our modeling studies have shown that in certain proportions, this mixture of amines can significantly reduce the energy required to regenerate the mixture by as much as 38%.

Certain embodiments consists of a ternary amine blend to capture CO₂ from industrial gas streams, wherein MEA comprises about 10 wt. % to about 20 wt. %, MDEA comprises about 4 wt. % to about 35 wt. %, and PZ comprises from about 5 wt. % to about 45 wt. % of the liquid amine solvent. In certain embodiments, MEA comprises about 12 wt. % to about 16 wt. %, MDEA comprises about 4 wt. % to about 10 wt. %, and PZ comprises from about 35 wt. % to about 45 wt. % of the liquid amine solvent. In certain embodiments, MEA comprises about 12 wt. % to about 16 wt. %, MDEA comprises about 4 wt. % to about 7 wt. %, and PZ comprises greater than about 40 wt. % of the liquid amine solvent. Typically, water comprises about 35 to 45 wt. % of the liquid amine solvent. In certain embodiments, additional amine blends of PZ, MEA, and MDEA may also be utilized. The MDEA component of the blend can optionally be replaced by other amines such as, for example, Diethanolamine (DEA), Diisopropylamine (DIPA), or Triethanolamine (TEA).

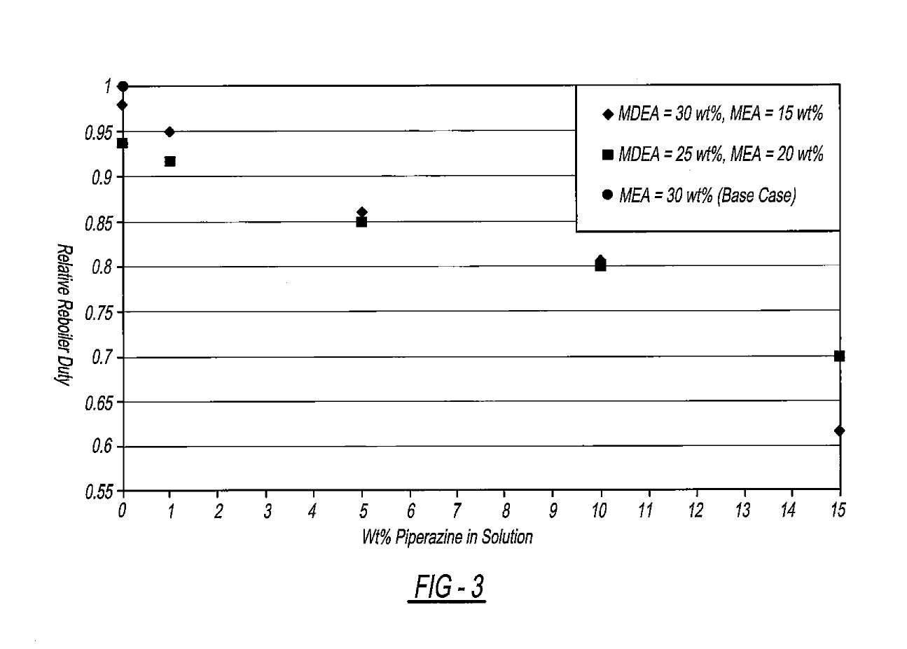

Computer modeling (see Example 1) has demonstrated that these amines in the proper proportions can reduce the energy needed to regenerate the amine solvent by up to 38% (see FIG. 3). As a tertiary amine, MDEA does not require as much regeneration energy as MEA, but is also less active than it. Without being bound by theory, it is speculated that the advantage of the ternary amine blend described herein derives from the required regeneration energy of MEA being lowered by blending it with MDEA, and then compensating for the activity loss of the blend of MEA/MDEA by adding piperazine as a promoter. A tertiary amine (such as, for example, MDEA or TEA) may act as the proton sink for the amine-enzyme blend, thereby allowing the blend's promoter, enzyme, and/or primary amine to have higher activity. As mentioned above, in certain embodiments, the MDEA component of the blend can be replaced by other amities such as, for example, DEA, DIPA, TEA to achieve a reduction in the overall energy needed to regenerate the amine solvent, which can yield significant reduction in reboiler duty as compared to MEA.

### EXAMPLES

The following examples of certain embodiments of the invention are given. Each example is provided by way of explanation of the invention, one of many embodiments of the invention.

The following examples are intended to be illustrative of a specific embodiment of the present invention in order to teach one of ordinary skill in the art how to make and use the invention, and the following examples should not be interpreted as limiting or defining the scope of the invention in any way.

### Example 1

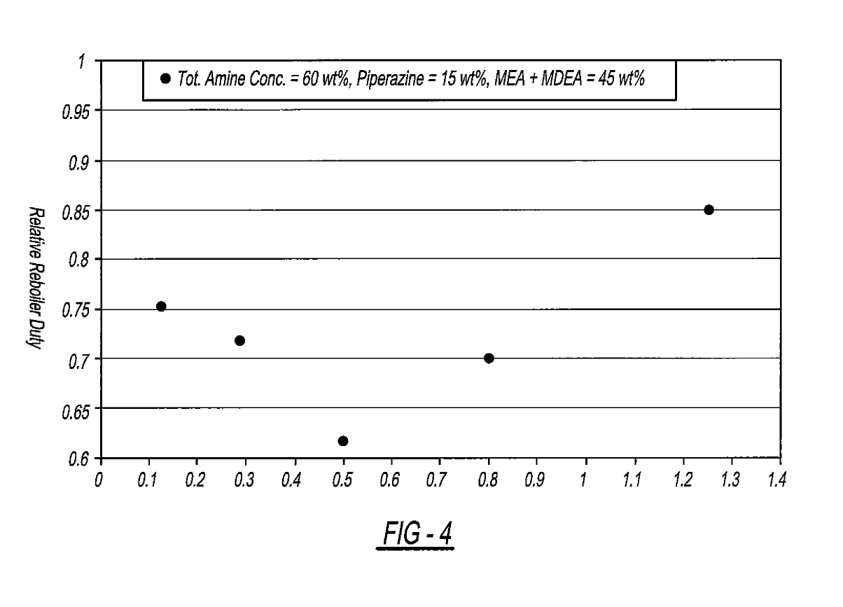

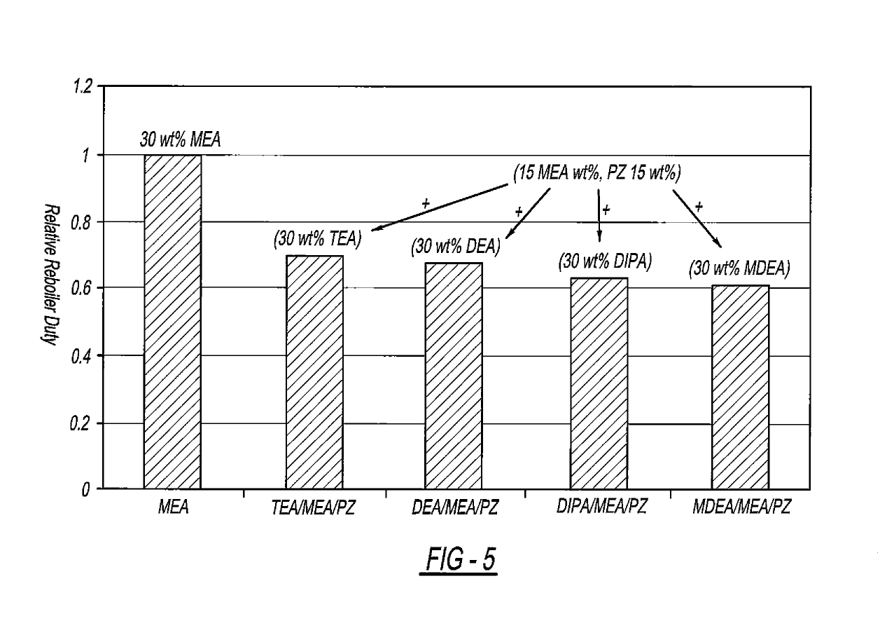

Computer modeling was performed to determine the energy required to remove 90% of the CO₂ from a flue gas in a conventional amine scrubber process (see FIG. 1). The process was modeled in ProMax (a commercial amine process simulator) with both a standard aqueous MEA solution (MEA+Water) and an aqueous ternary amine blend (MEA+MDEA+Piperazine+Water). The composition of the ternary blend was varied, and the energy required to regenerate the blend following absorption of CO₂ was determined. The properties of the hypothetical flue gas used in this testing is shown in Table 1 and Table 2, while the amine compositions tested (with corresponding regenerator reboiler duties) are shown in Table 3. The data of Table 3 is graphically depicted in FIGS. 3-5. As seen in Table 3, the reboiler duty (in MMBTU/hr) required to regenerate the ternary amine blend was usually less than MEA alone. The mixtures of MDEA and MEA containing 15 wt % piperazine had the lowest regeneration energy requirements (shown in FIG. 3), which were as much as 38% less than the energy required for regeneration of MEA alone. FIG. 4 shows that with the concentration of piperazine held steady at 15 wt %, the optimal ratio of MEA/MDEA was determined to be 0.5. FIG. 5 demonstrates that in a mixture comprising MEA at 15 wt. % and PZ at 15 wt. %, replacing the MDEA component with 30 wt. % of triethanolamine (TEA), diethanolamine (DEA) or diisopropylamine (DIPA) also significantly reduced regeneration energy as compared to MEA alone.

TABLE 1
Test Flue Gas Properties

| Flue Gas Properties | Value |
|---|---|
| Temperature before cooling (° F.) | 392 |
| Pressure (psia) | 14.9 |
| Molar Flow (lbmole/hr) | 50,141.6 |
| Mass Flow (lb/hr) | 1,395,490 |
| Std Vapor Volumetric Flow | 456.7 |
| (MMSCFD) | |
| Molecular Wt (lb/lbmole) | 27.8 |

TABLE 2
Test Flue Gas Composition

| Flue Gas Composition | |
|---|---|
| (lbmole %) | |
| CO₂ | 8.5 |
| N₂ | 72.3 |
| O₂ | 2.7 |
| H₂O | 16.5 |

TABLE 3
Aqueous Amine Compositions and Reboiler Duty Results

| Aqueous Amine Composition (wt %) | | | | Regenerator |
|---|---|---|---|---|
| MDEA | MEA | Piperazine | Water | Reboiler Duty |
| ((CH3N(C₂H₄OH)₂) | (C₂H₂NO) | (C₄H₁₀N₂) | (H₂O) | (MMBTU/hr) |
| 0 | 30 | 0 | 70 | 243.2 |
| 30 | 15 | 0 | 55 | 238.3 |
| 30 | 15 | 1 | 54 | 231.4 |
| 30 | 15 | 5 | 50 | 209.6 |
| 30 | 15 | 10 | 45 | 195.5 |
| 30 | 15 | 15 | 40 | 150.0 |
| 25 | 20 | 0 | 55 | 228.1 |
| 25 | 20 | 1 | 54 | 223.0 |
| 25 | 20 | 5 | 50 | 206.3 |
| 25 | 20 | 10 | 45 | 194.8 |
| 25 | 20 | 15 | 40 | 170.5 |
| 20 | 25 | 15 | 40 | 207.1 |
| 15 | 30 | 15 | 40 | 251.7 |
| 40 | 5 | 15 | 40 | 183.3 |
| 35 | 10 | 15 | 40 | 174.8 |

### DEFINITIONS

As used herein, the acronym MEA is synonymous with monoethanolamine, the acronym MDEA is synonymous with methyl diethanolamine, and the abbreviation PZ is synonymous with piperazine.

In closing, it should be noted that the discussion of any reference is not an admission that it is prior art to the present invention, especially any reference that may have a publication date after the priority date of this application. At the same time, each and every claim below is hereby incorporated into this detailed description or specification as a additional embodiments of the present invention.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

Any reference cited herein is expressly incorporated by reference. The discussion of any reference is not an admission that it is prior art to the present invention, especially any reference that may have a publication data after the priority date of this application.

We claim:

1. A process for the removal of carbon dioxide from a gas, comprising:
a) passing a first gas comprising carbon-dioxide into a first absorption zone;
b) contacting the first gas with a liquid amine solvent in the first absorption zone and transferring a portion of the carbon dioxide in the first gas to the liquid amine solvent to produce a second gas comprising a reduced quantity of carbon dioxide relative to the first gas and a carbon dioxide-laden liquid amine solvent;
c) passing the second gas to a second absorption zone, and contacting therein with an advanced solvent comprising an ionic liquid, a naturally-occurring enzyme, a genetically-modified enzyme, a synthetic analogue of an enzyme, or mixtures thereof;
d) transferring at least a portion of the carbon dioxide in the second gas to the advanced solvent to produce a third gas comprising a reduced quantity of carbon dioxide relative to the second gas and a spent advanced solvent;
e) conveying the carbon dioxide-laden liquid amine solvent of step (b) to a first regeneration zone, wherein the first regeneration zone is maintained at a temperature and pressure sufficient to liberate carbon dioxide from the carbon dioxide-laden liquid amine solvent, thereby producing a regenerated liquid amine solvent that is at least partly recycled to the first absorption zone;
f) conveying the spent advanced solvent of step (d) to a second regeneration zone that is maintained at a temperature and pressure sufficient to liberate carbon dioxide from the spent advanced solvent, thereby producing a regenerated advanced solvent that is at least partly recycled to the second absorption zone, wherein the temperature within the second regeneration zone is less than the temperature of the first regeneration zone, thereby prolonging the activity of the advanced solvent.

2. The process of claim 1, wherein the liquid amine solvent comprises monoethanolamine in a range from about 10 wt. % to about 20 wt. %, methyl diethanolamine in a range from about 4 wt. % to about 35 wt. %, and piperazine in a range from about 5 wt. % to about 45 wt. %.

3. The process of claim 1, wherein the liquid amine solvent comprises monoethanolamine in a range from about 12 wt. % to about 16 wt. %, methyl diethanolamine in a range from about 4 wt. % to about 35 wt. %, and piperazine in a range from about 35 wt. % to about 45 wt. %.

4. The process of claim 1, wherein the first absorption zone and the second absorption zone are adjacent, but separate zones within a single absorption vessel, wherein the first absorption zone and the second absorption zone are separated by a water spray, a water quench vessel, a membrane, or combinations thereof.

5. The process of claim 1, wherein the liquid amine solvent is regenerated in a first regeneration zone, and the advanced solvent is regenerated in a second regeneration zone that is physically distinct from the first regeneration zone.

6. The process of claim 1, wherein the first absorption zone is maintained at a temperature in the range of 40° F. to 175° F. and a pressure of up to about 50 psig, and wherein the first regeneration zone is maintained a temperature in a range from about 180° F. to about 280° F. and a pressure of up to about 50 psig.

7. The process of claim 1, wherein the advanced solvent comprises an enzyme, a genetically-modified enzyme, a synthetic analogue of an enzyme or mixtures thereof, wherein the second absorption zone is maintained at a temperature of less than 140° F. and a pressure of up to about 50 psig, and wherein the second regeneration zone is maintained a temperature in a range from about 104° F. to about 194° F. and a pressure of up to about 50 psig.

8. The process of claim 1, wherein the advanced solvent comprises an ionic liquid, wherein the second absorption zone is maintained at a temperature in a range from about 104° F. to about 575° F. and a pressure of up to about 50 psig, and wherein the second regeneration zone is maintained at a temperature in a range of about 104° F. to about 220° F. and a pressure of up to about 50 psig.

9. The process of claim 1, wherein the advanced solvent comprises a naturally-occurring form of carbonic anhydrase, a genetically-modified carbonic anhydrase, a synthetic analogue of carbonic anhydrase, or mixtures thereof.

10. The process of claim 1, wherein the first gas is a natural gas or flue gas.

11. A system for the removal of carbon dioxide from a gas, comprising:
a) A liquid amine solvent;
b) a first vessel comprising a first absorption zone and adapted for:
containing the liquid amine solvent,
receiving a first gas comprising carbon dioxide,
allowing direct contact between the liquid amine solvent and the first gas, thereby facilitating the transfer of carbon dioxide from the first gas to the liquid amine solvent and producing a second gas and a carbon dioxide-laden liquid amine solvent;
c) an advanced solvent comprising an ionic liquid, an enzyme, a genetically-modified enzyme, a synthetic analogue of an enzyme or mixtures thereof;
d) a second vessel comprising a second absorption zone, and adapted for:
containing the advanced solvent,
receiving the second gas,
allowing direct contact between the advanced solvent and the second gas, thereby facilitating transfer of at least a portion of the carbon dioxide from the second gas to the advanced solvent and producing a third gas and a spent advanced sorbent;
e) a third vessel comprising a first regeneration zone, and adapted for:
receiving the carbon dioxide-laden liquid amine solvent from a first absorption zone,
maintaining conditions of temperature and pressure that facilitate the removal of carbon dioxide from the carbon dioxide-laden liquid amine solvent;
f) a fourth vessel comprising a second regeneration zone that is distinct from the first regeneration zone, and adapted for:
receiving the carbon dioxide-laden advanced solvent from the second absorption zone,
maintaining conditions of temperature and pressure that facilitate the liberation of carbon dioxide from the spent advanced solvent, wherein said temperature is less than the temperature maintained in the first regeneration zone

12. The system of claim 11, wherein the liquid amine solvent comprises monoethanolamine, methyl diethanolamine and piperazine, wherein monoethanolamine comprises about 10 wt. % to about 20 wt. %, methyl diethanolamine comprises about 4 wt. % to about 35 wt. %, and piperazine comprises from about 5 wt. % to about 45 wt. % of the liquid amine solvent.

13. The system of claim 11, wherein monoethanolamine comprises about 12 wt. % to about 16 wt. %, methyl diethanolamine comprises about 4 wt. % to about 10 wt. %, and piperazine comprises from about 35 wt. % to about 45 wt. % of the liquid amine solvent.

14. The system of claim 11, wherein the advanced solvent comprises a naturally-occurring form of carbonic anhydrase, a genetically-modified carbonic anhydrase, a synthetic analogue of carbonic anhydrase or mixtures thereof.

15. The system of claim 11, wherein the third reactor comprising a first regeneration zone is adapted for regenerating the liquid amine solvent, and the second regeneration zone is adapted to regenerate the advanced solvent, wherein the second regeneration zone is physically separated from the first regeneration zone.

16. The system of claim 11, wherein the first reactor comprising a first absorption zone is adapted for maintaining a temperature in the range of 40° F. to 175° F. and a pressure of up to about 50 psig, and wherein the third reactor comprising a first regeneration zone is suitable for maintaining a temperature in a range from about 180° F. to about 280° F. and a pressure of up to about 50 psig.

17. The system of claim 11, wherein the advanced solvent comprises an enzyme, a genetically-modified enzyme, a synthetic analogue of an enzyme or mixtures thereof, wherein the second reactor comprising a second absorption zone is adapted for maintaining a temperature of less than about 140° F. and a pressure of up to about 50 psig, and wherein the fourth reactor comprising a second regeneration zone is adapted for maintaining a temperature in a range from about 104° F. to about 194° F. and a pressure of up to about 50 psig.

18. The system of claim 11, wherein the advanced solvent comprises an ionic liquid, wherein the second reactor comprising a second absorption zone is adapted for maintaining a temperature in a range from about 104° F. to about 575° F. and a pressure of up to about 50 psig, and wherein the fourth reactor comprising second regeneration zone is adapted for maintaining a temperature in a range of about 104° F. to about 220° F. and a pressure of up to about 50 psig.

19. The system of claim 11, wherein the first reactor and the second reactor are adjacent and in direct contact and are separated by a water spray, a water quench vessel, a membrane, or combinations thereof.

20. The system of claim 11, wherein the first gas is a natural gas or a combustion flue gas.
